(19) United States
(12) Patent Application Publication
(10) Pub. No.: US 2017/0351447 A1
(43) Pub. Date: Dec. 7, 2017

(54) DATA PROTECTION IMPLEMENTATION FOR BLOCK STORAGE DEVICES

(71) Applicant: Scale Computing, Inc., Indianapolis, IN (US)

(72) Inventor: Philip Andrew White, Renton, WA (US)

(21) Appl. No.: 15/173,256

(22) Filed: Jun. 3, 2016

(51) Int. Cl. G06F 3/06

(52) U.S. Cl. CPC G06F 3/0622; G06F 3/0679; G06F 3/0631; G06F 3/0637; G06F 3/0664

(57) ABSTRACT

A system, method, and computer program product are provided for implementing a data protection algorithm using reference counters. The method includes the steps of allocating a first portion of a real storage device to store data, wherein the first portion is divided into a plurality of blocks of memory; allocating a second portion of the real storage device to store a plurality of reference counters that correspond to the plurality of blocks of memory; and disabling access to a particular block of memory in the plurality of blocks of memory based on a value stored in a corresponding reference counter. Access to a particular block of memory may be disabled when the value stored in the corresponding reference counter is not equal to a total number of references to the particular block of memory.

### FIELD OF THE INVENTION

The present invention relates to data protection, and more particularly to a technique for monitoring block storage devices for potential data corruption.

### BACKGROUND

Reference counting refers to a technique for tracking a number of references (i.e., pointers or handles) to a particular resource of a computer system. For example, a portion of memory in system RAM (Random Access Memory) may be allocated to store an instantiation of an object associated with an application. A handle to that object is stored in a variable and a reference count for the object is set to one. The reference count indicates that there is one variable in memory that refers to the object via the handle. If the handle is copied into another variable, then the reference count may be incremented. If the variable storing the handle is overwritten, then the reference count may be decremented. Any resource having a reference count of zero can be safely reallocated because there is no longer any active reference that points to that resource.

Some systems may include a resource that is implemented as a block device. A block device includes a number of blocks of non-volatile memory. Hard disk drives, optical drives, and solid state drives are all examples of hardware devices that can be implemented as a block device. When an operating system allocates a block of the block device to a particular process or processes, the operating system also typically allocates space in system RAM to store reference counters associated with the block.

Some contemporary systems may implement a hypervisor on a node along with one or more virtual machines. Virtual machines are logical devices that emulate shared hardware resources connected to the node. In other words, two or more virtual machines may be implemented on the same node and configured to share common resources such as a processor, memory, or physical storage devices. The hypervisor may implement one or more virtual storage devices that emulate a real storage device for the virtual machines. The virtual storage device may contain a plurality of blocks of memory that are stored in one or more physical storage devices connected to the node. Contiguous blocks on the virtual storage device may refer to non-contiguous blocks on one or more physical storage devices. When reference counting is used in conjunction with the virtual storage devices, the reference counters associated with the virtual storage device may be stored in the RAM.

It will be appreciated that reference counters may possibly get corrupted during certain operations. For example, reference counters may be incremented or decremented during a particular operation that subsequently fails (e.g., due to a faulty network connection, disk failure, power failure, timeout, software bug, and the like). Such operations may cause the reference count for a resource to not match the number of valid references to the resource. In such cases, the resource could be reallocated prematurely, allowing new data to overwrite the data that currently has a valid reference within the system. Furthermore, the resource may not be able to be re-allocated because the reference count is greater than zero even when valid references to the resource do not exist. Such failures may tie up needed resources unnecessarily. Thus, there is a need for addressing this issue and/or other issues associated with the prior art.

### SUMMARY

A system, method, and computer program product are provided for implementing a data protection algorithm using reference counters. The method includes the steps of allocating a first portion of a real storage device to store data, wherein the first portion is divided into a plurality of blocks of memory; allocating a second portion of the real storage device to store a plurality of reference counters that correspond to the plurality of blocks of memory; and disabling access to a particular block of memory in the plurality of blocks of memory based on a value stored in a corresponding reference counter. Access to a particular block of memory may be disabled when the value stored in the corresponding reference counter is not equal to a total number of references to the particular block of memory.

### BRIEF DESCRIPTION OF THE DRAWINGS

FIG. 1 illustrates a flowchart of a method for implementing a data protection algorithm using reference counters associated with a plurality of virtual storage devices, according to one embodiment;

FIG. 2 illustrates a cluster having a plurality of nodes, in accordance with one embodiment;

FIGS. 3A & 3B are conceptual diagrams of the architecture for a node of FIG. 2, in accordance with one embodiment;

FIG. 4 illustrates the abstraction layers implemented by the block engine daemon for two nodes of the cluster, in accordance with one embodiment;

FIG. 5A illustrates the allocation of a real storage device, in accordance with one embodiment;

FIG. 5B is a conceptual illustration for the sharing of reference counters among a plurality of virtual storage devices, in accordance with one embodiment;

FIG. 6A illustrates an implementation of a data protection algorithm utilizing reference counters stored on the real storage devices, in accordance with one embodiment;

FIG. 6B illustrates a mapping table for a virtual storage device object, in accordance with one embodiment;

FIG. 7 illustrates a flowchart of a method for determining whether a reference counter for a block is valid, in accordance with one embodiment; and

FIG. 8 illustrates an exemplary system in which the various architecture and/or functionality of the various previous embodiments may be implemented.

### DETAILED DESCRIPTION

A system may include a cluster of nodes, each node configured to host a plurality of virtual machines. The cluster of nodes is configured such that each node in the cluster of nodes includes a set of hardware resources such as a processor, a memory, a host operating system, one or more storage devices, and so forth. Each node may implement one or more virtual machines that execute a guest operating system configured to manage a set of virtual resources that emulate the hardware resources of the node. Each node also implements a block engine daemon process that is configured to allocate hardware resources for a set of virtual storage devices. The block engine daemon communicates with a set of client libraries implemented within the guest operating systems of the virtual machines. The block engine daemon also implements a real storage device abstraction layer as well as a virtual storage device abstraction layer. The real storage device abstraction layer includes a set of objects corresponding to the one or more physical storage devices included in the node as well as a set of objects corresponding to one or more additional storage devices included in other nodes of the cluster. The virtual storage device abstraction layer includes a set of objects corresponding to at least one logical storage device accessible by the virtual machines.

The block engine daemon is configured to track various parameters related to the storage devices within the cluster. For example, the block engine daemon maintains data that identifies a location for each of the storage devices connected to the cluster. The block engine daemon may also implement a protocol for allocating space in, reading data from, and writing data to the physical storage devices. The block engine daemon may also manage a set of reference counters associated with the real storage devices. The reference counters may be maintained in a portion of memory in the real storage devices rather than maintaining reference counters in the shared memory (i.e., RAM) allocated to the virtual machines implemented by the nodes. Consequently, multiple virtual storage devices can transparently share those reference counters without requiring the various nodes or virtual machines in the cluster to communicate each action related to the shared real storage devices to the other nodes or virtual machines.

A separate system monitor process may actively monitor the resource counters to determine when blocks of the real storage devices may be corrupted. Resource counts may become inaccurate due to various software bugs or system failures. Inaccurate resource counts can cause valid data to be overwritten (i.e., blocks may be reallocated) or may prevent blocks from being reallocated when the blocks are no longer pointed to by a valid reference, thereby consuming valuable system resources.

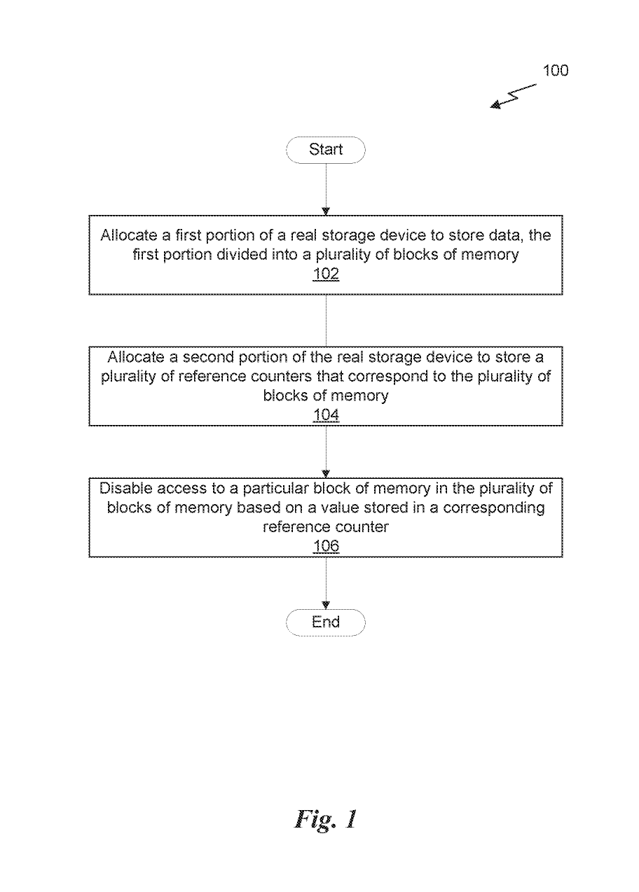

FIG. 1 illustrates a flowchart of a method 100 for implementing a data protection algorithm using reference counters associated with a plurality of virtual storage devices, according to one embodiment. Although the method 100 is described in the context of a program executed by a processor, the method 100 may also be performed by custom circuitry or by a combination of custom circuitry and a program. At step 102, a first portion of a real storage device is allocated to store data. The real storage device is a block device and the first portion of the block device is divided into a plurality of blocks of memory. In the context of the following description, a real storage device is any physical device capable of storing data in blocks of memory. For example, real storage devices may include hard disk drives, optical disc drives, solid state drives, magnetic media, and the like. The real storage devices may be connected to a processor via any of the interfaces well-known in the art such as Serial Advance Technology Attachment (SATA), Small Computer System Interface (SCSI), and the like. In the context of the following description, a virtual storage device is a logical drive that emulates a real storage device. Virtual storage devices provide a logical interface for the virtual machines to access data in one address space that is mapped to a second address space on one or more real storage devices. Virtual storage devices may also implement redundant data storage, such as by storing multiple copies of data in different locations.

In one embodiment, a block engine daemon implements a level of abstraction that represents the real storage devices. The level of abstraction may represent each of the real storage devices with a real storage device object, which is an instantiation of a class that includes fields storing information related to the real storage device and methods for implementing operations associated with the real storage device. The methods may include operations for allocating a block of memory within the real storage device to store data, writing data to the real storage device, and reading data from the real storage device. The block engine daemon may also implement a level of abstraction that represents the virtual storage devices. The level of abstraction may represent the virtual storage device with a virtual storage device object, which is an instantiation of a class that includes fields storing information related to the virtual storage device and methods for implementing operations associated with the virtual storage device. For example, the fields may include a mapping table that associates each logical block of memory in the virtual storage device with a corresponding block of memory in the real storage device, a size of the virtual storage device, current performance statistics for the device, and so forth. The methods may include operations for allocating a block of memory within the virtual storage device to store data, writing data to the virtual storage device, and reading data from the virtual storage device.

At step 104, a second portion of the real storage device is allocated to store a plurality of reference counters that correspond to the plurality of blocks of memory in the first portion of the real storage device. As used herein, a reference counter is a number of bits (e.g., 16-bits) that stores a value associated with a particular block of memory. In one embodiment, when the value is equal to zero, the corresponding block of memory is available to be allocated for new data. When the value is greater than zero, the corresponding block of memory is referenced by at least one virtual block of memory in at least one virtual storage device. The reference counters may be updated by two or more virtual machines hosted in one or more nodes to manage the allocation of the blocks of memory in the real storage device. It will be appreciated that a base value of zero represents a block of memory with no references associated with any virtual storage devices and that the value is incremented for each reference to the block that is created. In another embodiment, any base value may be used to indicate that the block of memory has no outstanding references, and the value may be incremented or decremented when new references are created or destroyed.

At step 106, access to a particular block of memory in the plurality of blocks of memory is disabled based on a value stored in a corresponding reference counter. In one embodiment, a data protection module scans the values stored in each reference counter and checks the values against the number of references to the blocks of memory corresponding to the reference counters. In other words, the data protection module is configured to poll each virtual storage device to determine if that virtual storage device includes a reference to a block of memory. The number of references to the block of memory across all virtual storage devices are counted, and the calculated value is compared against the value stored in the reference counter for the block of memory. If the values are different, then the data in the block of memory is potentially corrupt and the block of memory will be flagged. Any block of memory that has been flagged is disabled, and no additional I/O operations (i.e., read/write) may be performed using that block of memory until the block of memory is enabled and the flag is cleared.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

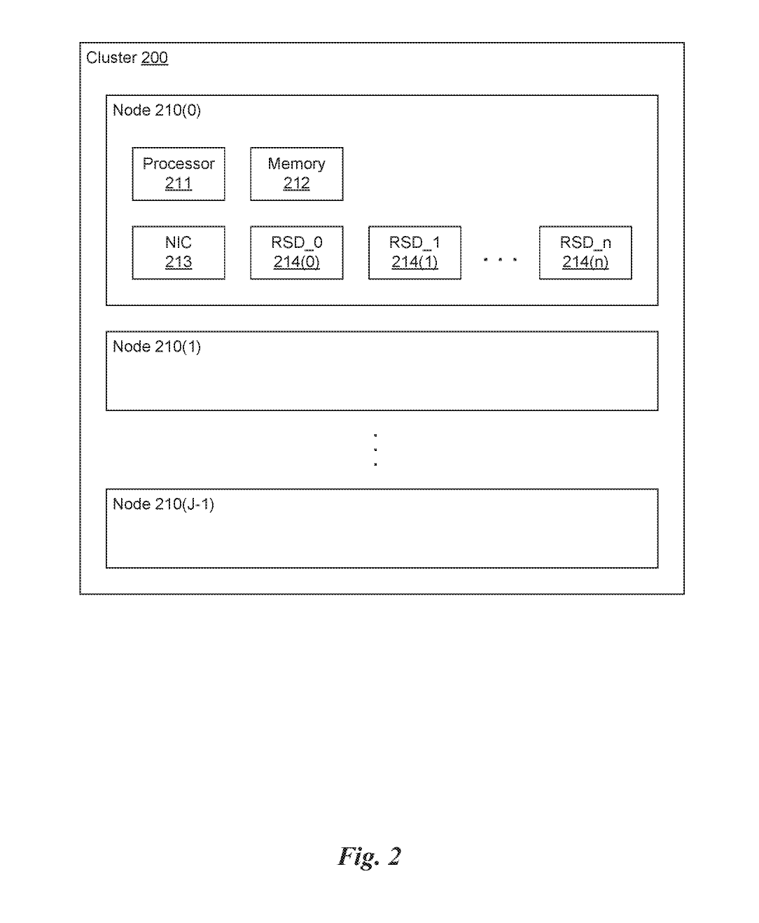

FIG. 2 illustrates a cluster 200 having a plurality of nodes 210, in accordance with one embodiment. As shown in FIG. 2, the cluster 200 includes J nodes (i.e., node 210(0), node 210(1), . . . , node 210(J−1)). Each node 210 includes a processor 211, a memory 212, a NIC 213, and one or more real storage devices (RSD) 214. The processor 211 may be an x86-based processor, a RISC-based processor, or the like. The memory 212 may be a volatile memory such as a Synchronous Dynamic Random-Access Memory (SDRAM) or the like. The NIC 213 may implement a physical layer and media access control (MAC) protocol layer for a network interface. The physical layer may correspond to various physical network interfaces such as IEEE (Institute of Electrical and Electronics Engineers) 802.3 (Ethernet), IEEE 802.11 (WiFi), and the like. In one embodiment, the memory 212 includes a host operating system kernel, one or more device drivers, one or more applications, and the like. The host operating system kernel may be, e.g., based on the Linux® kernel such as the Red Hat® Enterprise Linux (RHEL) distribution. It will be appreciated that, although not explicitly shown, each node 210 may include one or more other devices such as GPUs, additional microprocessors, displays, radios, or the like.

As used herein an RSD 214 is a physical, non-volatile memory device such as a HDD, an optical disk drive, a solid state drive, a magnetic tape drive, and the like that is capable of storing data. The one or more RSDs 214 may be accessed via an asynchronous input/output functionality implemented by a standard library of the host operating system or accessed via a non-standard library that is loaded by the operating system, in lieu of or in addition to the standard library. In one embodiment, the host operating system may mount the RSDs 214 and enable block device drivers to access the RSDs 214 for read and write access.

The RSDs 214 may implement a file system including, but not limited to, the FAT32 (File Allocation Table—32-bit), NTFS (New Technology File System), or the ext2 (extended file system 2) file systems. In one embodiment, each RSD 214 may implement logical block addressing (LBA). LBA is an abstraction layer that maps blocks of the disk (e.g., 512B blocks of a hard disk) to a single unified address. The unified address may be 28-bit, 48-bit, or 64-bit wide that can be mapped, e.g., to a particular cylinder/head/sector tuple of a conventional HDD or other data storage space.

The memory 212 may also include a hypervisor that performs hardware virtualization. In one embodiment, QEMU (Quick EMUlator) is provided for emulating one or more VMs on each node of the cluster 200. In such embodiments, each node 210 may be configured to load a host operating system such as RHEL into the memory 212 on boot. Once the host operating system is running, the QEMU software is launched in order to instantiate one or more VMs on the node 210, each VM implementing a guest operating system that may or may not be the same as the host operating system. It will be appreciated that QEMU may generate VMs that can emulate a variety of different hardware architectures such as x86, PowerPC, SPARC, and the like.

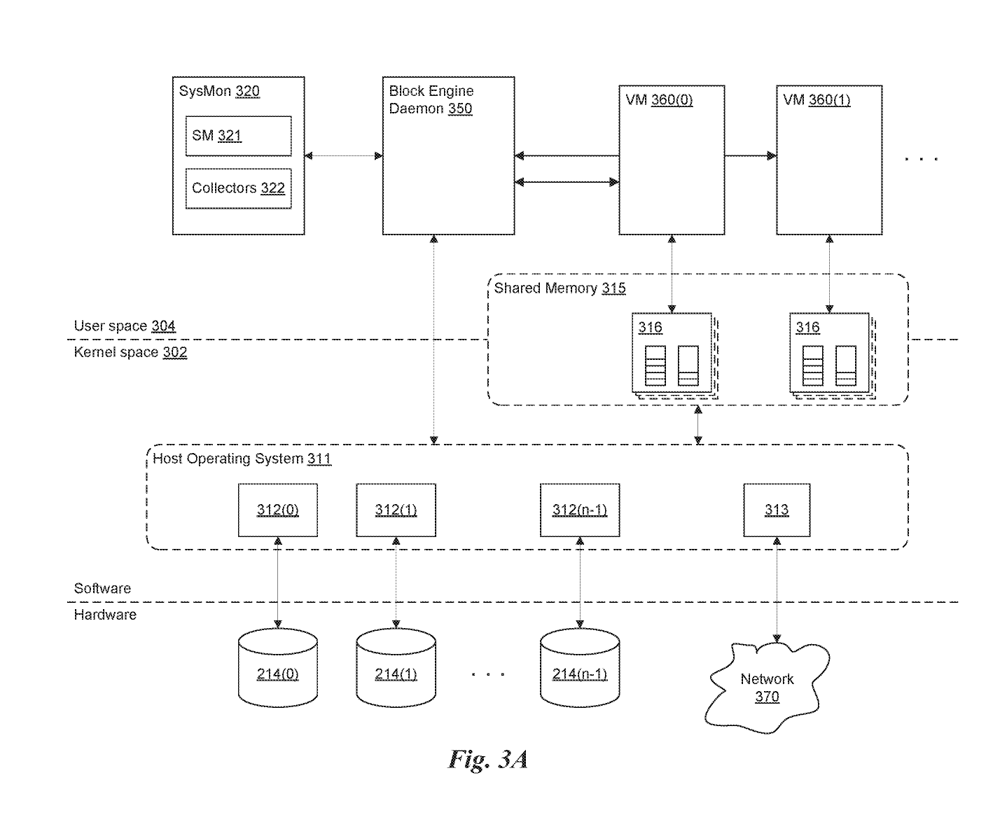

FIGS. 3A & 3B are conceptual diagrams of the architecture for a node 210 of FIG. 2, in accordance with one embodiment. As shown in FIG. 3A, the node 210 may execute a host operating system 311 that implements a protected mode of operation having at least two privilege levels including a kernel space 302 and a user space 304. For example, the host operating system 311 may comprise the Linux® kernel as well as one or more device drivers 312 and 313 that execute in the kernel space 302. The device drivers 312 enable applications in the user space 304 to read or write data from/to the RSDs 214 via a physical interface such as SATA (serial ATA), SCSI (Small Computer System Interface), FC (Fibre Channel), and the like. In one embodiment, the device drivers 312 are generic block device drivers included in the host operating system 311. The device driver 313 enables applications to communicate with other nodes 210 in the cluster 200 via a network interface, which may be wired (e.g., SONET/SDH, IEEE 802.3, etc.) or wireless (e.g., IEEE 802.11, etc.). In one embodiment, the device driver 313is a generic network driver included in the host operating system 311. It will be appreciated that other device drivers, not explicitly shown, may be included in the host operating system 311, such as device drivers for input devices (e.g., mice, keyboards, etc.), output devices (e.g., monitors, printers, etc.), as well as any other type of hardware coupled to the processor 211.

The conceptual diagram in FIG. 3A shows the RSDs 214 and network 370 within the hardware abstraction layer. In other words, the RSDs 214 and network 370 comprise physical devices having a physical interface to the processor 211 in the node 210, either directly or indirectly through a system bus or bridge device. FIG. 3A also illustrates a software abstraction layer that includes objects and processes resident in the memory 212 of the node 210. The processes may be executed by the processor 211. For example, the host operating system 311, system monitor (SysMon) 320, Block Engine (BE) Daemon 350, and virtual machines (VMs) 360 are processes that are executed by the processor 211.

In one embodiment, the host operating system 311 may allocate a portion of the memory 212 as a shared memory 315 that is accessible by the one or more VMs 360. The VMs 360 may share data in the shared memory 315. The host operating system 311 may execute one or more processes configured to implement portions of the architecture for a node 210. For example, the host operating system 311 executes the BE Daemon 350 in the user space 304. The BE Daemon 350 is a background process that performs tasks related to the block devices coupled to the node 210 (i.e., the RSDs 214). The SysMon 320 implements a state machine (SM) 321 and a set of collectors 322 for managing the instantiation and execution of one or more VMs 360 that are executed in the user space 304. In addition, the SysMon 320 may be configured to manage the provisioning of virtual storage devices (VSDs). VSDs may be mounted to the VMs 360 to provide applications running on the VMs 360 access to the RSDs 214 even though the applications executed by the VMs 360 cannot access the RSDs 214 directly. In one embodiment, the SysMon 320 creates I/O buffers 316 in the shared memory 315 that enable the VMs 360 to read data from or write data to the VSDs mounted to the VM 360. Each VM 360 may be associated with multiple I/O buffers 316 in the shared memory 315. For example, each VSD mounted to the VM 360 may be associated with an input buffer and an output buffer, and multiple VSDs may be mounted to each VM 360.

As shown in FIG. 3B, each instance of the VM 360 implements a guest operating system 361, a block device driver 362, and a block engine client 363. The guest OS 361 may be the same as or different from the host operating system 311. The guest OS 361 comprises a kernel 365 that implements a virtual I/O driver 366 that is logically coupled to a VSD. Each VSD is a logical storage device that maps non-contiguous blocks of storage in one or more RSDs 214 to a contiguous, logical address space of the VSD. The VSD logically appears and operates like a real device coupled to a physical interface for the guest OS 361, but is actually an abstraction layer between the guest OS 361 and the physical storage blocks on the RSDs 214 coupled to the node 210, either directly or indirectly via the network 370. The guest OS 361 may execute one or more applications 364 that can read and write data to the VSD via the virtual I/O driver 366. In some embodiments, two or more VSDs may be associated with a single VM 360.

The block device driver 362 and the BE client 363 implement a logical interface between the guest OS 361 and the VSD. In one embodiment, the block device driver 362 receives read and write requests from the virtual I/O driver 366 of the guest OS 361. The block device driver 362 is configured to write data to and read data from the corresponding I/O buffers 316 in the shared memory 315. The BE client 363 is configured to communicate with the BE server 352 in the BE Daemon 350 to schedule I/O requests for the VSDs.

The BE Daemon 350 implements a Block Engine Remote Protocol 351, a Block Engine Server 352, a VSD Engine 353, an RSD Engine 354, and an I/O Manager 355. The Block Engine Remote Protocol 351 provides access to remote RSDs 214 coupled to other nodes 210 in the cluster 200 via the network 370. The BE Server 352 communicates with one or more BE Clients 363 included in the VMs 360. Again, the BE Client 363 generates I/O requests related to one or more VSDs for the BE Server 352, which then manages the execution of those requests. The VSD Engine 353 enables the BE Server 352 to generate tasks for each of the VSDs. The RSD Engine 354 enables the VSD Engine 353 to generate tasks for each of the RSDs 214 associated with the VSDs. The RSD Engine 354 may generate tasks for local RSDs 214 utilizing the I/O Manager 355 or remote RSDs 214 utilizing the BE Remote Protocol 351. The I/O Manager 355 enables the BE Daemon 350 to generate asynchronous I/O operations that are handled by the host OS 311 to read from or write data to the RSDs 214 connected to the node 210. Functions implemented by the I/O Manager 355 enable the BE Daemon 350 to schedule I/O requests for one or more VMs 360 in an efficient manner. The BE Server 352, VSD Engine 353, RSD Engine 354, I/O Manager 355 and BE Remote Protocol 351 are implemented as a protocol stack.

In one embodiment, the VSD Engine 353 maintains state and metadata associated with a plurality of VSD objects 355. Each VSD object 355 may include a mapping table that associates each block of addresses (i.e., an address range) in the VSD with a corresponding block of addresses in one or more RSDs 214. The VSD Engine 353 may maintain various state associated with a VSD such as a VSD identifier (i.e., handle), a base address of the VSD object 355 in the memory 212, a size of the VSD, a format of the VSD (e.g., filesystem, block size, etc.), and the like.

Similarly, the RSD Engine 354 maintains state and metadata associated with a plurality of RSD objects 356. Each RSD object 356 may correspond to an RSD 214 connected to the node 210 or an RSD 214 accessible on another node 210 via the network 370. The RSD Engine 354 may maintain various state associated with each RSD 214 such as an RSD identifier (i.e., handle), a base address of the RSD object 356 in the memory 212, a size of the RSD 214, a format of the RSD 214 (e.g., filesystem, block size, etc.), and the like. The RSD Engine 354 may also track errors associated with each RSD 214.

The VSD objects 355 and the RSD objects 356 are abstraction layers implemented by the VSD Engine 353 and RSD Engine 354, respectively, that enable VMs 360, via the BE Daemon 350, to store data on the RSDs 214. In one embodiment, the VSD abstraction layer is a set of objects defined using an object-oriented programming (OOP) language. As used herein, an object is an instantiation of a class and comprises a data structure in memory that includes fields and pointers to methods implemented by the class. The VSD abstraction layer defines a VSD class that implements a common interface for all VSD objects 355 that includes the following methods: Create; Open; Close; Read; Write; Flush; Discard; and a set of methods for creating a snapshot of the VSD. A snapshot is a data structure that stores the state of the VSD at a particular point in time. The Create method generates the metadata associated with a VSD and stores the metadata on an RSD 214, making the VSD available to all nodes 210 in the cluster 200. The Open method enables applications in the VMs 360 to access the VSD (i.e., the I/O buffers 316 are generated in the shared memory 315 and the VSD is mounted to the guest OS 361). The Close method prevents applications in the VMs 360 from accessing the VSD. The Read method enables the BE Server 352 to read data from the VSD. The Write method enables the BE Server 352 to write data to the VSD. The Flush method flushes all pending I/O requests associated with the VSD. The Discard method discards a particular portion of data stored in memory associated with the VSD.

In one embodiment, two types of VSD objects 355 inherit from the generic VSD class: a SimpleVSD object and a ReliableVSD object. The SimpleVSD object is a simple virtual storage device that maps each block of addresses in the VSD to a single, corresponding block of addresses in an RSD 214. In other words, each block of data in the SimpleVSD object is only stored in a single location. The SimpleVSD object provides a high performance virtual storage solution but lacks reliability. In contrast, the ReliableVSD object is a redundant storage device that maps each block of addresses in the VSD to two or more corresponding blocks in two or more RSDs 214. In other words, the ReliableVSD object provides n-way replicated data and metadata. The ReliableVSD object may also implement error checking with optional data and/or metadata checksums. In one embodiment, the ReliableVSD object may be configured to store up to 15 redundant copies (i.e., 16 total copies) of the data stored in the VSD. The SimpleVSD object may be used for non-important data while the ReliableVSD object attempts to store data in a manner that prevents a single point of failure (SPOF) as well as provide certain automatic recovery capabilities when one or more nodes experiences a failure. The VSD Engine 353 may manage multiple types of VSD objects 355 simultaneously such that some data may be stored on SimpleVSD type VSDs and other data may be stored on ReliableVSD type VSDs. It will be appreciated that the two types of VSDs described herein are only two possible examples of VSD objects 355 inheriting from the VSD class and other types of VSD objects 355 are contemplated as being within the scope of the present disclosure.

The RSD Engine 354 implements an RSD abstraction layer that provides access to all of the RSDs 214 coupled to the one or more nodes 210 of the cluster 200. The RSD abstraction layer enables communications with both local and remote RSDs 214. As used herein, a local RSD is an RSD 214 included in a particular node 210 that is hosting the instance of the BE Daemon 350. In contrast, a remote RSD is an RSD 214 included in a node 210 that is not hosting the instance of the BE Daemon 350 and is accessible via the network 370. The RSD abstraction layer provides reliable communications as well as passing disk or media errors from both local and remote RSDs 214 to the BE Daemon 350.

In one embodiment, the RSD abstraction layer is a set of objects defined using an OOP language. The RSD abstraction layer defines an RSD class that implements a common interface for all RSD objects 356 that includes the following methods: Read; Write; Allocate; and UpdateRefCounts. Each RSD object 356 is associated with a single RSD 214. In one embodiment, the methods of the RSD class are controlled by a pair of state machines that may be triggered by either the reception of packets from remote nodes 210 on the network 370 or the expiration of timers (e.g., interrupts). The Read method enables the VSD Engine 353 to read data from the RSD 214. The Write method enables the VSD Engine 353 to write data to the RSD 214. The Allocate method allocates a block of memory in the RSD 214 for storing data. The UpdateRefCounts method updates the reference counts for each block of the RSD 214, enabling deallocation of blocks with reference counts of zero (i.e., garbage collection).

In one embodiment, two types of RSD objects 356 inherit from the RSD class: an RSDLocal object and an RSDRemote object. The RSDLocal object implements the interface defined by the RSD class for local RSDs 214, while the RSDRemote object implements the interface defined by the RSD class for remote RSDs 214. The main difference between the RSDLocal objects and the RSDRemote objects are that the I/O Manager 355 asynchronously handles all I/O between the RSD Engine 354 and local RSDs 214, while the BE Remote Protocol 351 handles all I/O between the RSD Engine 354 and remote RSDs 214.

As discussed above, the SysMon 320 is responsible for the provisioning and monitoring of VSDs. In one embodiment, the SysMon 320 includes logic for generating instances of the VSD objects 355 and the RSD objects 356 in the memory 212 based on various parameters. For example, the SysMon 320 may discover how many RSDs 214 are connected to the nodes 210 of the cluster 200 and create a different RSD object 356 for each RSD 214 discovered. The SysMon 320 may also include logic for determining how many VSD objects 355 should be created and or shared by the VMs 360 implemented on the node 210. Once the SysMon 320 has generated the instances of the VSD objects 355 and the RSD objects 356 in the memory 212, the BE Daemon 350 is configured to manage the functions of the VSDs and the RSDs 214.

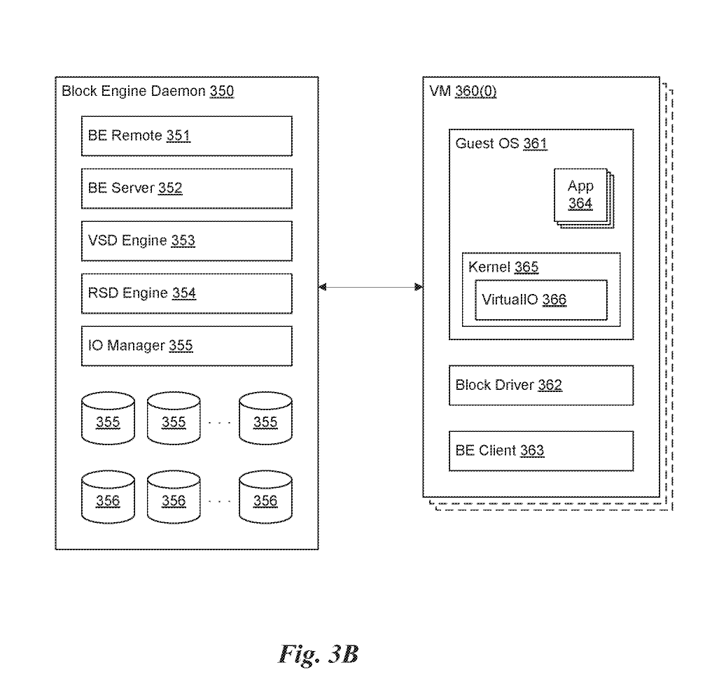

FIG. 4 is a conceptual diagram of the abstraction layers implemented by the BE Daemon 350 for two nodes 210 of the cluster 200, in accordance with one embodiment. A first node 210(0) is coupled to two local RSDs (i.e., 214(0) and 214(1)) and two remote RSDs (i.e., 214(2) and 214(3)) via the network 370. Similarly, a second node 210(1) is coupled to two local RSDs (i.e., 214(2) and 214(3)) and two remote RSDs (i.e., 214(0) and 214(1)) via the network 370. The RSD abstraction layer includes four RSD objects 356 (i.e., RSD 0, RSD 1, RSD 2, and RSD 3). In the first node 210(0), RSD 0 and RSD 1 are RSDLocal objects and RSD 2 and RSD 3 are RSDRemote objects.

The first node 210(0) accesses the first RSD 214(0) and the second RSD 214(1) via the I/O Manager library that makes system calls to the host operating system 311 in order to asynchronously read or write data to the local RSDs 214. An RSDLocal library is configured to provide an interface for applications communicating with the BE Daemon 350 to read or write to the local RSDs 214. The RSDLocal library may call methods defined by the interface implemented by the IOManager library. The first node 210(0) accesses the third RSD 214(2) and the fourth RSD 214(3) indirectly via a Protocol Data Unit Peer (PDUPeer) library that makes system calls to the host operating system 311 in order to communicate with other nodes 210 using the NIC 213. The PDUPeer library generates packets that include I/O requests for the remote RSDs (e.g., 214(2) and 214(3)). The packets may include information that specifies the type of request as well as data or a pointer to the data in the memory 212. For example, a packet may include data and a request to write the data to one of the remote RSDs 214. The request may include an address that specifies a block in the RSD 214 to write the data to and a size of the data. Alternately, a packet may include a request to read data from the remote RSD 214. The RSDProxy library unpacks requests from the packets received from the PDUPeer library and transmits the requests to the associated local RSD objects 356 as if the requests originated within the node 210.

The BE Remote Protocol 351, the BE Server 352, VSD Engine 353, RSD Engine 354, and the I/O Manager 355 implement various aspects of the RSD abstraction layer shown in FIG. 4. For example, the BE Remote Protocol 351 implements the RSDProxy library and the PDUPeer library, the RSD Engine 354 implements the RSDRemote library and the RSDLocal library, and the I/O Manager 355 implements the IOManager library. The second node 210(1) is configured similarly to the first node 210(0) except that the RSD objects 356 RSD 0 and RSD 1 are RSDRemote objects linked to the first RSD 214(0) and the second RSD 214(1), respectively, and the RSD objects 356 RSD 2 and RSD 3 are RSDLocal objects linked to the third RSD 214(2) and the fourth RSD 214(3), respectively.

The VSD abstraction layer includes three VSD objects 355 (i.e., VSD 0, VSD 1, and VSD 2). In the first node 210(0), VSD 0 and VSD 1 are ReliableVSD objects. In the second node 210(1), VSD 2 is a ReliableVSD object. It will be appreciated that one or more of the VSD objects 355 may be instantiated as SimpleVSD objects, and that the particular types of objects chosen depends on the characteristics of the system. Again, the VSD objects 355 provide an interface to map I/O requests associated with the corresponding VSD to one or more corresponding I/O requests associated with one or more RSDs 214. The VSD objects 355, through the Read or Write methods, are configured to translate the I/O request received from the BE Server 352 and generate corresponding I/O requests for the RSD(s) 214 based on the mapping table included in the VSD object 355. The translated I/O request is transmitted to the corresponding RSD 214 via the Read or Write methods in the RSD object 356.

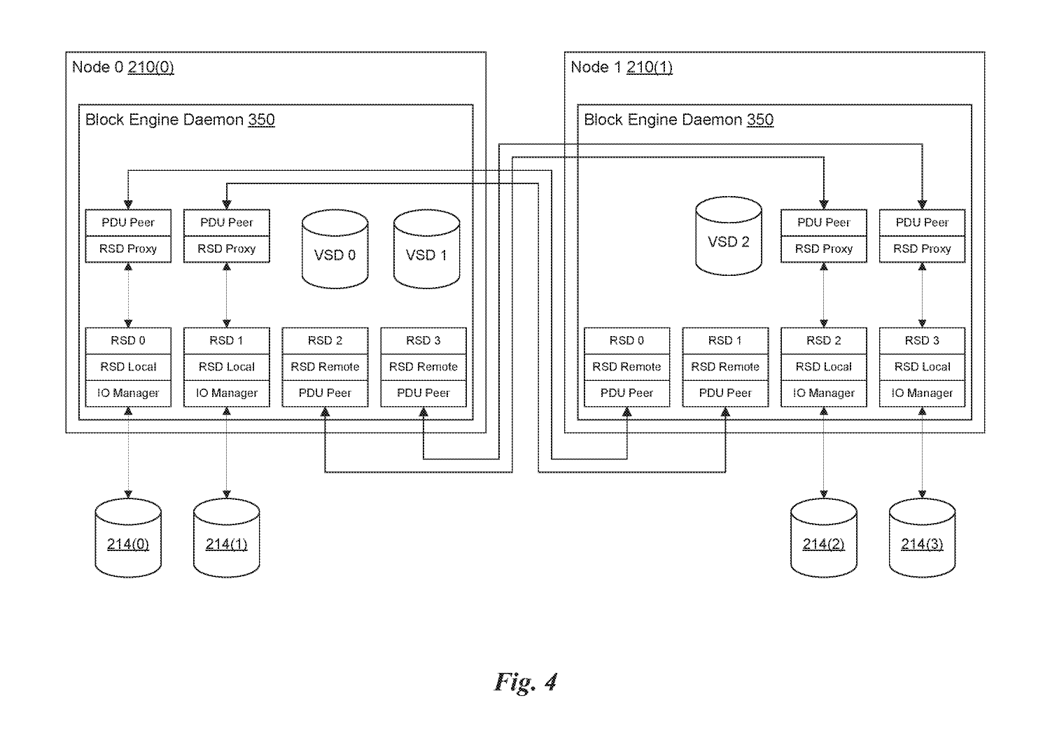

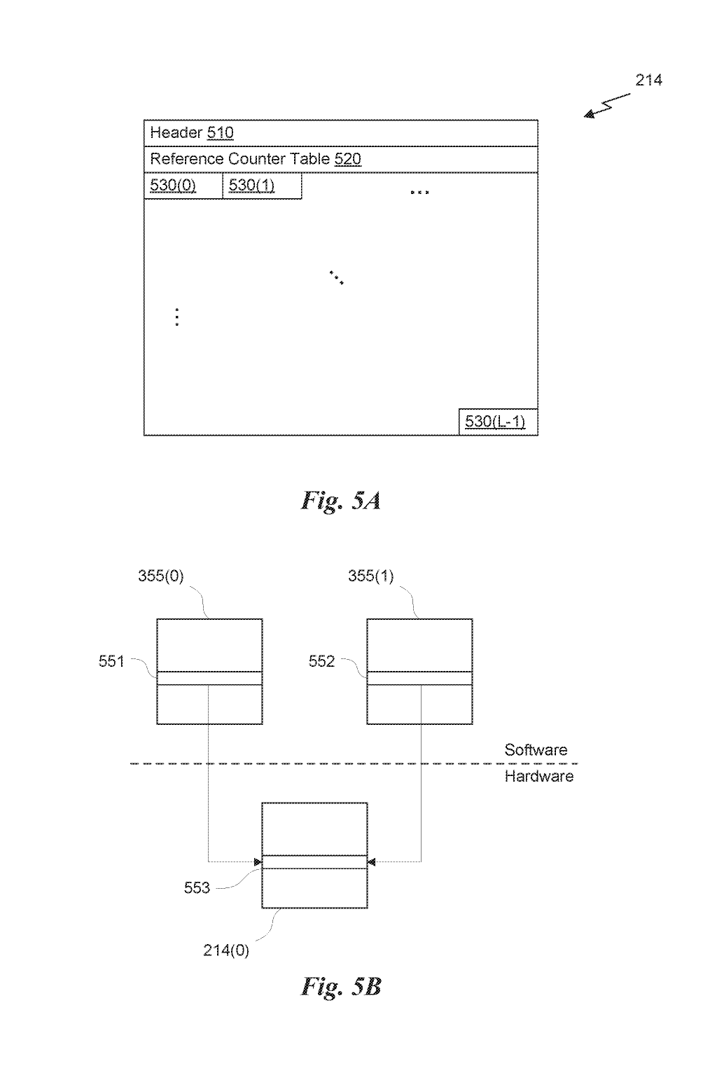

FIG. 5A illustrates the allocation of an RSD 214, in accordance with one embodiment. As shown in FIG. 5A, the RSD 214 includes a header 510, a reference counter table 520, and a plurality of blocks of memory 530(0), 530(1), . . . , and 530(L−1). The header 510 includes various information such as a unique identifier for the RSD 214, an identifier that indicates a type of file system implemented by the RSD 214, an indication of whether ECC checksums are implemented for data reliability, and the like. The reference counter table 520 is included in a first portion of the RSD 214 and includes a vector of reference counters, each reference counter in the vector being associated with a particular block of memory 530 included in a second portion of the RSD 214.

In one embodiment, each block of memory 530 is associated with a particular reference counter in the vector. A reference counter may be any number of bits representing an integer that is incremented each time a reference to the block of memory 530 is created and decremented each time a reference to the block of memory 530 is overwritten or destroyed. A reference refers to the mapping of a block of memory in a VSD to a block of memory in the RSD 214. In one embodiment, each reference counter may be 16-bits wide. If each memory address in the first portion of the RSD 214 refers to 64-bits of data, then a value stored in the memory identified by a particular address of the reference counter table 520 will include 4 reference counters associated with 4 blocks of memory 530 in the second portion of the RSD 214. In another embodiment, each block of memory 530 may be associated with two or more reference counters in the vector. For example, a block of memory 530 may comprise a number of sub-blocks, where each sub-block is associated with a separate and distinct reference counter in the reference counter table 520. For example, a block of memory 530 may comprise 4096 bytes whereas each reference counter is associated with a 512 byte sub-block. It will be appreciated that the sizes of blocks and sub-blocks given here are for illustrative purposes and that the sizes of blocks and sub-blocks in a particular RSD 214 may have other sizes. For example, each block may be 1 MB in size and reference counters may be associated with 4096 byte sectors of the drive. In such an embodiment, sub-blocks of the blocks of memory 530 may be allocated separately to separate VSDs.

In another embodiment, reference counters may be allocated dynamically as memory of variable size is allocated to store various objects. When the BE server 352 allocates one or more blocks of memory 530 in the RSD 214 for an object, the BE server 352 also assigns an available reference counter to that object. The reference counter may include both a counter (e.g., a 16-bit value) and an address that identifies the base address for the block(s) of memory 530 associated with the reference counter as well as a number of contiguous block(s) of memory 530 that are associated with that reference counter. In this manner, each reference counter does not refer to a fixed portion of the memory in the RSD 214 but instead refers to a particular contiguous allocation of memory in the RSD 214. It will be appreciated that the number of reference counters required to implement this system will vary and, therefore, this embodiment may be more complex to implement and may decrease the efficiency of memory access operations.

FIG. 5B is a conceptual illustration for the sharing of reference counters among a plurality of VSDs, in accordance with one embodiment. A node 210 may include an RSD 214(0) that is shared by two or more VSDs. The node 210 may implement one or more VMs 360 as well as a plurality of VSDs represented by a plurality of VSD objects 355. As shown in FIG. 5B, a first VSD object 355(0) and a second VSD object 355(1) are implemented as software constructs in the memory 212. It will be appreciated that the first VSD object 355(0) and the second VSD object 355(1) are stored in the memory 212, which is also a hardware device, but since the first VSD object 355(0) and the second VSD object 355(1) are virtual devices, they are shown on the software side of the hardware/software abstraction boundary. A virtual block of memory 551 in the first VSD object 355(0) is mapped to a corresponding block of memory 553 in the RSD 214(0). Similarly, a virtual block of memory 552 in the second VSD object 355(1) is mapped to the block of memory 553 in the RSD 214(0). In other words, the block of memory 553 in the RSD 214(0) is referenced by two different VSDs. The first VSD object 355(0) and the second VSD object 355(1) may be mounted in the same virtual machine 360 or different virtual machines 360 instantiated on the node 210. Similarly, the first VSD object 355(0) and the second VSD object 355(1) may be mounted in different virtual machines 360 instantiated on different nodes 210 connected via the network 370.

The RSD 214(0) includes at least one reference counter in the reference counter table 520 (not explicitly shown in FIG. 5B) of the RSD 214(0). As applications are executed by the VMs 360, references associated with the blocks of memory in the RSD 214(0) are created or destroyed based on the instructions of the applications. For example, an application executing in a first VM 360 may request the allocation of a virtual block of memory 551 in the first VSD to store data for the application. The BE client 363 may request the BE server 352 to allocate the memory in the VSD. The BE server 352 then requests the VSD Engine 353 to allocate a virtual block of memory 551 in a the VSD, which corresponds to a particular VSD object 355(0). The VSD object 355(0) requests a block 553 of memory to be allocated in the RSD 214(0) to store the data for the virtual block of memory 551 in the VSD, and adds a pointer corresponding to the allocated block of memory 553 to the mapping table of the VSD object 355(0) that maps the virtual block of memory 551 in the VSD to the corresponding block of memory 553 in the RSD 214(0). If the VSD is a Reliable VSD, then the process is repeated for a number of blocks in different RSDs 214 to store redundant copies of the data. Allocating blocks of memory in this fashion creates the reference(s) to the block of memory 553 in the RSD 214(0). Thus, the reference counter will be incremented to indicate that a first reference exists in the system and that the data in the block of memory 553 should not be reclaimed as part of a garbage collection routine.

Similarly, an application executing in a second VM 360 may also request the allocation of a virtual block of memory 552 in the second VSD to store a copy of the data associated with the virtual block of memory 551 in the first VSD. The VSD Engine 353 may add a pointer corresponding to the block of memory 553 to the VSD object 355(1) that maps the virtual block of memory 552 in the second VSD to the corresponding block of memory 553 in the RSD 214(0). Allocating blocks of memory in this fashion creates a second reference to the block of memory 553. The reference counter is then incremented again to indicate that there are now two references to the block of memory 553 in the system.

Reference counters stored on the RSDs 214 enable data protection to be implemented that protects data from being corrupted and, more importantly, may enable automatic recovery routines to transparently correct errors. Again, certain operations may be interrupted that cause the values stored in the reference counters to not match the actual number of valid references within the cluster 200. For example, power failures or system crashes may occur that cause nodes 210 of the cluster 200 to go offline, causing any references to a block 530 of an RSD 214 that are included in a VSD in a different node 210 to disappear. The reference counters may not be updated properly when these nodes 210 go offline and, therefore, the reference count may remain greater than zero even when no valid references to a particular block 530 of the RSD 214 exist in the cluster 200. In such cases, garbage collection routines may not mark the block as part of a free block allocation pool to be re-allocated to a different process. In another example, software bugs may not properly increment or decrement a particular reference counter whenever a reference is created or destroyed. If reference counts are not properly maintained, then it may be possible for a reference counter to have a value of zero even when valid references to the block 530 of the RSD 214 still exist in the cluster 200. An invalid reference counter may enable a block 530 to be re-allocated prematurely, enabling data referenced by a block of a particular VSD to be overwritten with different data referenced by a block of another VSD. Such corruption of data can be avoided by monitoring the reference counters and flagging any blocks 530 associated with invalid reference counters.

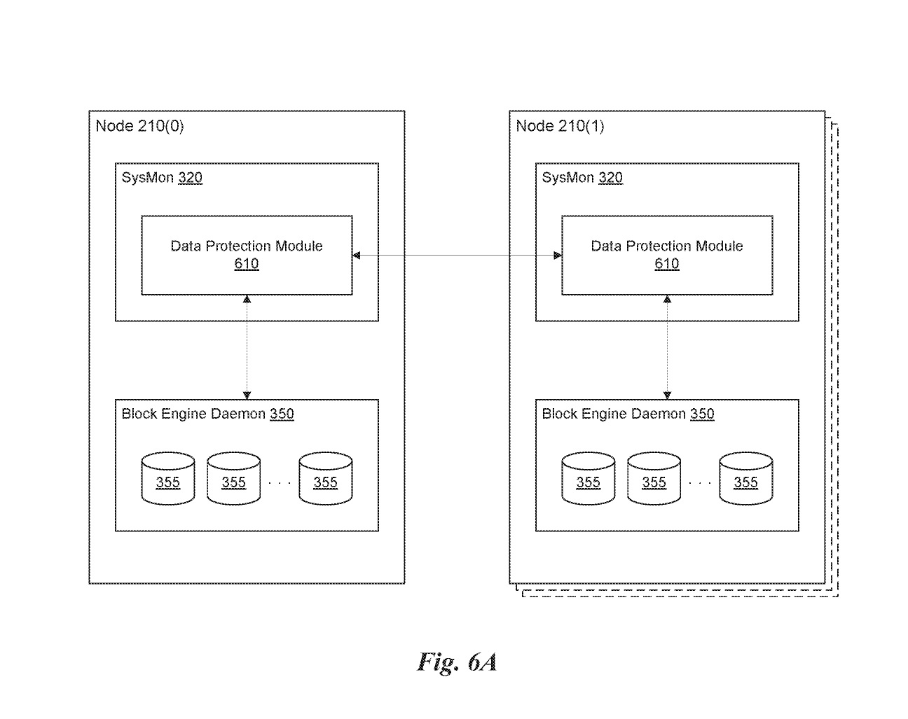

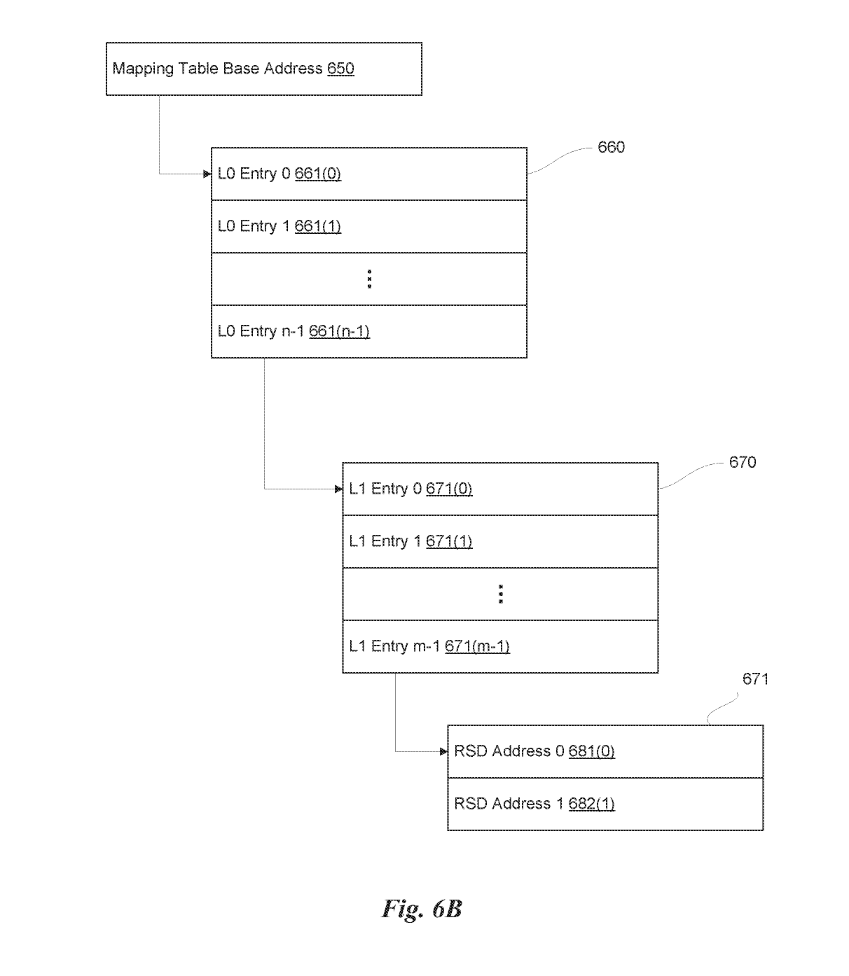

FIG. 6A illustrates an implementation of a data protection algorithm utilizing reference counters stored on the RSDs 214, in accordance with one embodiment. As shown in FIG. 6A, the SysMon 320 may include a data protection module 610, which is a particular instantiation of a collector 322 shown in FIG. 3A. The data protection module 610 may be executed periodically by the SysMon 320 to monitor the state of the reference counters stored in the RSDs 214 in the node 210. The data protection module 610 is configured to determine how many references there are for a particular block 530 of memory in the RSD 214, and then check that value against the value stored in a particular reference counter corresponding to the block 530 of memory. If the value in the reference counter does not match the number of references for the block 530, then the data protection module 610 may flag the block 530 as “frozen”. A “frozen” block 530 is protected from any further read/write operations and indicates that the data in the block 530 may be corrupted.

In order to determine the number of references that exist for a particular block 530 of memory in the RSD 214, the data protection module 610 may poll the VSD objects 355 to determine how many VSD objects 355 include a reference to that block 530. The polled VSD objects 355 may be included in that node 210 as well as other nodes 210 within the cluster 200. Once all of the VSD objects 355 are polled, and a total number of references for the block 530 are determined, then that value is compared against the value stored in the reference counter for the block 530. If the number of references does not match the value stored in the reference counter for the block 530, then the block 530 is flagged as frozen and no further read/write operations may be performed on the block 530.

In one embodiment, the most significant bit (MSB) of the reference counter may be used as a flag to mark the block 530 as frozen. For example, the MSB of a 16-bit reference counter field may be set to 1 if a block 530 is frozen and cleared to 0 if read/write operations are enabled for the block 530 (i.e., the block is “thawed”). The flag may be checked by the RSD Engine 354 any time a read/write operation is received. In one embodiment, if the flag is set, then the RSD Engine 354 may indicate that the operation failed due to the block being frozen by sending a message to the VSD Engine 353 using a callback function. If the flag is cleared, meaning the block is not frozen, then the RSD Engine 354 initiates an I/O operation for a particular RSD 214 by calling a function of the I/O Manager 355 in order to perform the read/write operation. In other words, the BE Daemon 350 is configured to block memory access operations associated with a particular block 530 of memory when the flag associated with the particular block of memory is set.

In one embodiment, the data protection module 610 checks all the allocated blocks 530 in any RSDs 214 included in the node 210. A list that identifies all of the allocated blocks 530 in an RSD 214 may be generated. For each block 530 in the list, the data protection module 610 then polls each of the VSD objects 355 included in the cluster 200 to determine if that particular VSD object 355 includes a reference to the block 530. The VSD object 355 includes a reference to the block 530 when a mapping table included in the VSD object 355 includes an RSD address that points to the block 530. The data protection module 610 counts the total number of valid references to the block 530 that exist in the cluster 200 and compares that sum to the value stored in the reference counter for the block 530. If the sum does not match the value in the reference counter, then a flag is set to mark the block as frozen. Setting the flag will prevent any new read/write operations from being performed on the block 530 as the VSD Engine 354 will prevent these operations from being transmitted to the I/O Manager 353.

In one embodiment, the data protection module 610 implements two modes of operation. In a scan mode, the data protection module 610 counts the number of references for each allocated block 530 in the RSDs 214 of a node 210. If a reference counter value for a block 530 is different than the collected count of references for the block 530, then the data protection module 610 flags the block 530. In a repair mode, the data protection module 610 may repair some of the flagged blocks. If the reference counter value is higher than the collected count of references for the block 530, then the data protection module 610 may decrement the reference counter value. If the reference counter value is lower than the collected count of references for the block 530, then the reference counter value is not adjusted. In both cases, the block 530 remains flagged and a network manager will be notified that support is required. The network manager must manually thaw the block 530 by clearing the flag. The scan mode may be periodically run by the SysMon 320 in order to flag potentially corrupt blocks 530. The repair mode may be run manually by the network manager in order to repair corrupt blocks 530.

In another embodiment, the data protection module 610 tracks which blocks 530 have been accessed recently and prioritizes checking reference counters for the recently accessed blocks 530. It may take a significant amount of time to determine how many valid references exist for each block 530 and, therefore, the time required to check all reference counters for an RSD 214 may be quite large. Priority may be made to first check the reference counters for those blocks 530 that have been accessed most recently, ensuring that such memory access requests did not result in corrupt reference counts. The algorithm may also prioritize checking the reference counters for blocks 530 that have not been checked within a certain time frame; e.g., the data protection module 610 may prioritize the checking of any reference counters that have not been checked within X number of hours or days when the corresponding block 530 has not been accessed. This timeout period ensures that all reference counters for an RSD 214 will be checked in due time even when some blocks 530 may be infrequently accessed or not accessed at all within the time frame. The algorithm may also implement a minimum time between checking a reference counter such that multiple memory access requests in a short time frame do not result in the data protection module 610 repeatedly checking the same reference counter for accuracy during a short span when a particular block 530 is repeatedly accessed by various processes.

In one embodiment, the data protection module 610 freezes a block 530 temporarily while the data protection module 610 determines the number of references for the block 530 that exist in the cluster 200. Freezing the block 530 temporarily prevents references from being created or destroyed while the data protection module 610 is processing a specific block 530. In other words, while the data protection module 610 is counting the valid references for a block 530, no process should be completed that could change the reference counter for the block 530. Once the data protection module 610 has finished processing a block 530, the flag for the block 530 may be cleared in order to allow processes to access the block 530.

In another embodiment, the data protection module 610 does not freeze the block 530 while collecting the count of the number of references to the block 530. Instead the data protection module 610 monitors I/O accesses associated with any blocks 530 being scanned. The data protection module tracks those blocks 530 that may have had reference counters updated during the scan and invalidates all counts associated with those blocks 530. These blocks 530 will not be flagged due to the potentially invalid count of references, allowing these blocks to be rescanned at a later point in time. In practice, operations that update a reference count are rare enough to not be an impediment for completing the scan of all blocks over a small number of iterations.

The data protection module 610 may also freeze a block 530 based on the instant detection of an invalid reference count operation. For example, a block 530 may be frozen if an update reference count operation results in a reference counter with a negative value. In another example, a block 530 may be frozen if a reference counter is incorrectly set to zero even when a valid reference exists within the cluster and an update reference count operation attempts to increment the reference count based on, e.g., a snapshot of a VSD being created. Such operations may indicate an invalid reference counter without needing to poll each VSD object 355 in order to establish a count of the valid references to the block 530.

FIG. 6B illustrates a mapping table for a VSD object 355, in accordance with one embodiment. As shown in FIG. 6B, the VSD object 355 includes a base address 650 for a hierarchical mapping table that includes an L0 (level zero) table 660 and an L1 (level one) table 670. The mapping table essentially stores RSD addresses that map a particular block of the VSD to one or more blocks of RSDs 214, depending on the replication factor for the VSD. The base address 650 points to an array of entries 661 that comprise the L0 table 660. Each entry 661 includes a base address of a corresponding L1 table 670. Similarly, the L1 table 670 comprises an array of entries 671 corresponding to a plurality of blocks of the VSD. Each entry 671 may include an array of RSD addresses that point to one or more blocks 530 in one or more RSDs 214 that store copies of the data for the block of the VSD. The number of RSD addresses stored in each entry 671 of the L1 table 670 depends on the replication factor of the VSD. For example, a replication factor of two would include two RSD addresses in each entry 671 of the L1 table 670. Although each entry 671 of the L1 table 670 is shown as including two RSD addresses, corresponding to a VSD replication factor of two, a different number of RSD addresses may be included in each entry 671 of the L1 table 670. In one embodiment, up to 16 addresses may be included in each entry 671 of the L1 table 670.

In one embodiment, an RSD address is a 64-bit value that includes a version number, an RSD identifier (RSDid), and a sector. The version number may be specified by the 4 MSBs of the address, the RSDid may be specified by the next 12 MSBs of the address, and the sector may be specified by the 40 LSBs of the address (leaving 8 bits reserved between the RSDid and the sector). The 12-bit RSDid and the 40 bit sector specify a particular block 530 in an RSD 214 that stores data for the corresponding block of a VSD.

In one embodiment, the VSD objects 355 implement methods for checking whether the VSD includes a reference to a particular block 530 of an RSD 214. The method may take an RSD address for a particular block 530 as input and returns a value as output that indicates the number of references the VSD object 355 includes to the block 530 specified by the RSD address. For example, the method may return a 1 if the mapping table includes a single reference to the block 530 specified by the RSD address and 0 if the mapping table does not include a reference to the block 530. The method may also return a count of the number of references if the mapping table includes multiple references to the block 530 specified by the RSD address.

The data protection module 610 may call the method of each VSD object 355 included in the node 210 to check whether each VSD object 355 includes a reference to the block 530 and sum all the values returned by the method to get a value for the total number of references to the block 530 stored in that node. The data protection module 610 may also transmit a request to each additional node in the cluster 200 that requests the data protection module 610 in those nodes to count the number of references to that block 530 that are stored in the remote node 210. The data protection module 610 may then sum the values received from each additional node 210 with the value calculated for the local node to determine a total number of references to the block 530 that exist in the cluster 200. The data protection module 610 may then read the reference counter for the block 530 from the RSD 214 and compare the value stored in the reference counter with the total number of references to the block 530. If the value in the reference counter is equal to the total number of references, then the reference counter is valid and I/O operations for the block 530 remain enabled. However, if the value in the reference counter is not equal to the total number of references, then the reference counter is invalid and the block 530 is frozen by setting a flag (e.g., the MSB in the reference counter).

This data protection algorithm simply flags when blocks 530 of memory in the RSDs 214 may be corrupt. Various techniques for dealing with potentially corrupt blocks 530 of memory are beyond the scope of the instant specification. However, flagged blocks may be cleared manually or automatically.

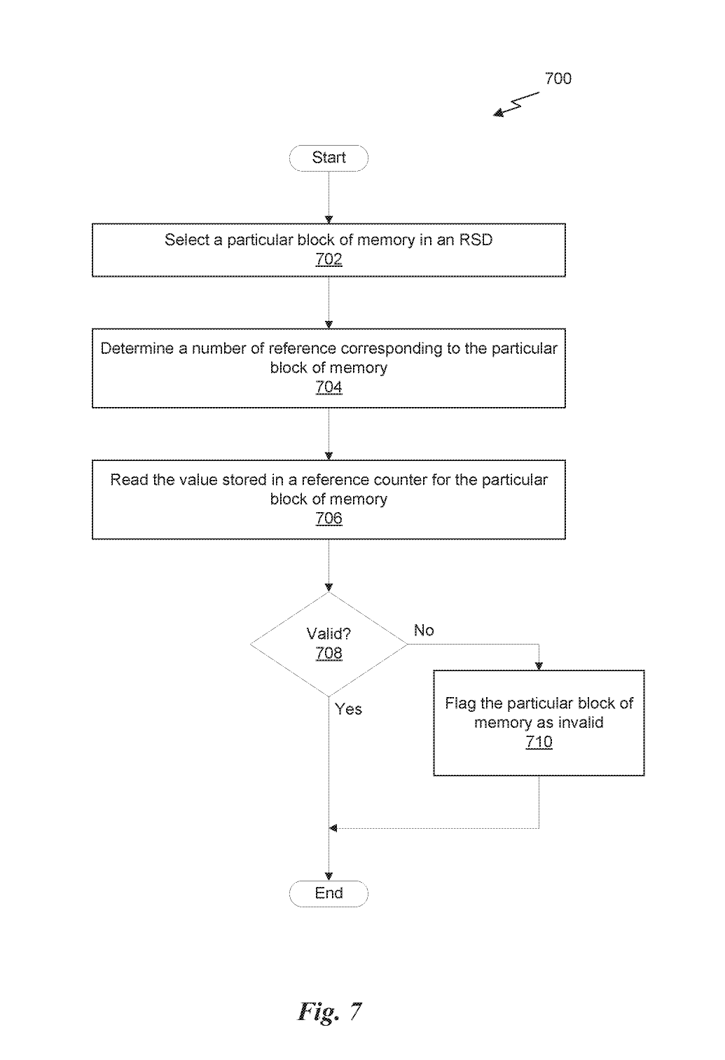

FIG. 7 illustrates a flowchart of a method 700 for determining whether a reference counter for a block 530 is valid, in accordance with one embodiment. Although the method is described in the context of a program executed by a processor, the method may also be performed by custom circuitry or by a combination of custom circuitry and a program. At step 702, the data protection module 610 selects a particular block 530 of memory in an RSD 214. At step 704, the data protection module 610 determines a number of references corresponding to the block 530 of memory. In one embodiment, the data protection module 610 polls each of the VSD objects 355 in the node 210 to determine how many of the VSD objects 355 include a reference to the block 530 of memory. A VSD object 355 may include a reference to the block 530 of memory when a mapping table of the VSD object 355 includes an RSD address that points to the block 530 of memory. The data protection module 610 may also transmit a message to a corresponding data protection module 610 in each of the other nodes 210 included in the cluster 200 that requests a total count of the number of references to the block 530 of memory included in VSD objects 355 stored in those nodes 210. The data protection module 610 may then sum all of the received counts to determine a total number of references to the block 530 of memory.

At step 706, the data protection module 610 reads the value stored in the reference counter for the block 530 of memory. In one embodiment, the reference counter stores a 16-bit value that operates as a signed integer that indicates the number of references to the block 530 of memory that should exist within the cluster 200. At step 708, the data protection module 610 determines if the reference counter is valid. If the value stored in the reference counter is equal to the number of references corresponding to the block 530 of memory, then the reference counter is valid and method 700 terminates. However, if the value stored in the reference counter is not equal to the number of references corresponding to the block 530 of memory, then the reference counter is invalid, and method 700 proceeds to step 710 where the data protection module 610 flags the block 530 as invalid. In one embodiment, the data protection module 610 sets the MSB of the 16-bit reference counter to indicate that the block 530 of memory is frozen, thereby disabling further read/write operations for the block 530 of memory. After the block 530 of memory is frozen, the method 700 terminates.

Although not explicitly shown in FIG. 7, the method 700 may be extended by automatically executing an error correction procedure to address the potentially corrupt data in the block 530 of memory. For example, after setting the flag to indicate that the block 530 of memory is potentially corrupt, the data protection module 610 may attempt to automatically correct the data by copying the data in the block 530 of memory from another block 530 of the same RSD 214 or a different RSD 214 that stores a copy of the data. For example, any VSD objects 355 that include a reference to the block 530 and have a replication factor greater than one may be read to find a different block in another RSD 214 that includes a copy of the data. The data in this different block may then be copied to the block 530. Once the data is copied, the reference counter may be reset to the number of references counted for the block 530 of memory by the data protection module 610 and the flag is cleared, enabling further read/write operations to be completed. Alternatively, the data protection module 610 may store a message in a queue that indicates to a network manager that the block 530 of memory is potentially corrupted. The network manager may then manually fix the corrupt data and advise software developers that there may be a bug in the software that is causing data to be corrupted. Alternatively, the network manager may simply invalidate the data in the block and reset the reference counter to zero such that the block may be reallocated to other processes.

Other error correction procedures may be followed in addition to the examples set forth above. In one embodiment, the data protection module 610 may allocate a new block 530 in the RSD 214 and copy the data from one of the replicated blocks to the new block 530. Any references to the flagged block 530 in any VSD object 355 may be changed to point to the new block 530, and the flagged block 530 may then be invalidated and the reference count may be set to zero such that the flagged block may be reallocated.

It will be appreciated that the above description of the functionality of the data protection module 610 is based on a one-to-one correspondence between reference counters and blocks 530. However, when multiple reference counters correspond to a particular block, such as when multiple reference counters area associated with multiple sub-blocks of a block, the functionality of the data protection module 610 as described as pertaining to a particular block may also extended to sub-blocks. In other words, the data protection module 610 may be configured to determine a number of references that exist for a particular sub-block and then compare the number of references to a value stored in a reference counter corresponding to that particular sub-block. In such cases, there is also a one-to-one correspondence between reference counters and sub-blocks. The use of the term block and sub-block may be interchanged as they simply refer to different sizes of a continuous range of addresses in the RSD 214.

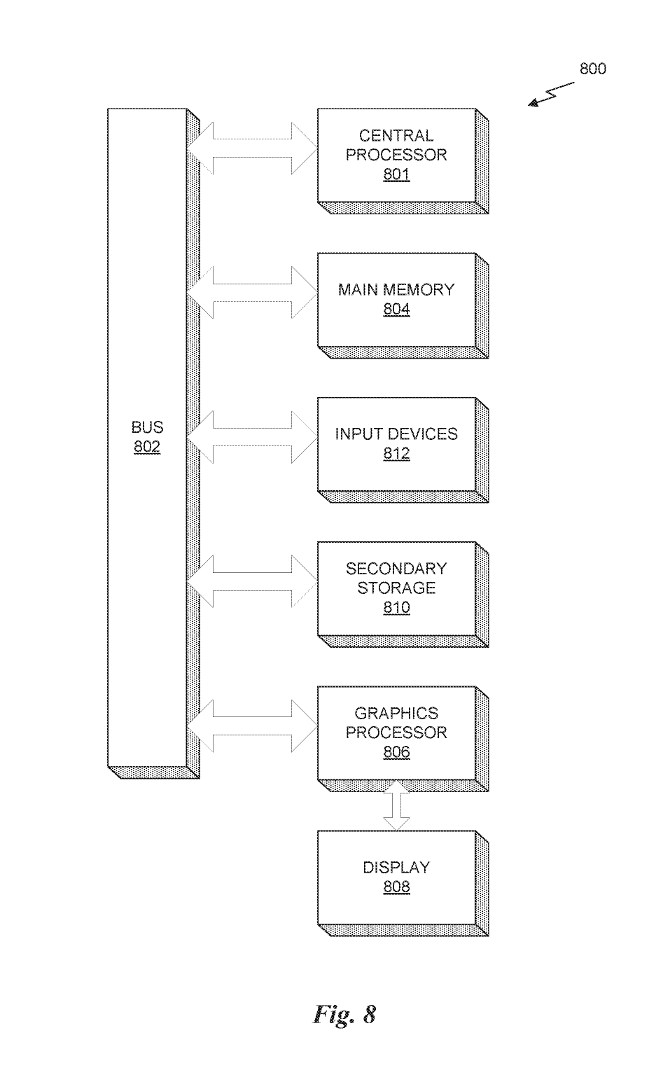

FIG. 8 illustrates an exemplary system 800 in which the various architecture and/or functionality of the various previous embodiments may be implemented. The system 800 may comprise a node 210 of the cluster 200. As shown, a system 800 is provided including at least one central processor 801 that is connected to a communication bus 802. The communication bus 802 may be implemented using any suitable protocol, such as PCI (Peripheral Component Interconnect), PCI-Express, AGP (Accelerated Graphics Port), HyperTransport, or any other bus or point-to-point communication protocol(s). The system 800 also includes a main memory 804. Control logic (software) and data are stored in the main memory 804 which may take the form of random access memory (RAM).

The system 800 also includes input devices 812, a graphics processor 806, and a display 808, i.e. a conventional CRT (cathode ray tube), LCD (liquid crystal display), LED (light emitting diode), plasma display or the like. User input may be received from the input devices 812, e.g., keyboard, mouse, touchpad, microphone, and the like. In one embodiment, the graphics processor 806 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage 810. Such computer programs, when executed, enable the system 800 to perform various functions. The memory 804, the storage 810, and/or any other storage are possible examples of computer-readable media.

In one embodiment, the architecture and/or functionality of the various previous figures may be implemented in the context of the central processor 801, the graphics processor 806, an integrated circuit (not shown) that is capable of at least a portion of the capabilities of both the central processor 801 and the graphics processor 806, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 800 may take the form of a desktop computer, laptop computer, server, workstation, game consoles, embedded system, and/or any other type of logic. Still yet, the system 800 may take the form of various other devices including, but not limited to a personal digital assistant (PDA) device, a mobile phone device, a television, etc.

Further, while not shown, the system 800 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
allocating a first portion of a real storage device (RSD) to store data, wherein the first portion is divided into a plurality of blocks of memory;
allocating a second portion of the RSD to store a plurality of reference counters that correspond to the plurality of blocks of memory; and
disabling access to a particular block of memory in the plurality of blocks of memory based on a value stored in a corresponding reference counter.

2. The method of claim 1, wherein access to the particular block of memory is disabled when the value stored in the corresponding reference counter is not equal to a total number of references to the particular block of memory included in a plurality of virtual storage device (VSD) objects.

3. The method of claim 2, wherein a reference to the particular block of memory comprises an address that points to the particular block of memory within a mapping table of the VSD object.

4. The method of claim 2, wherein a data protection module is configured to determine the total number of references to the particular block of memory by polling each VSD object in a plurality of VSD objects to determine whether each VSD object includes a reference to the particular block of memory in a mapping table of the VSD object.

5. The method of claim 4, wherein the plurality of VSD objects may be stored in a memory of a local node as well as memories of one or more remote nodes.

6. The method of claim 4, wherein the data protection module comprises a background process associated with a plurality of virtual machines.

7. The method of claim 1, wherein disabling access to the particular block of memory comprises setting a flag associated with the particular block of memory.

8. The method of claim 8, wherein the flag is a most significant bit of the corresponding reference counter.

9. The method of claim 8, wherein a block engine daemon is configured to block memory access operations associated with the particular block of memory when the flag is set.

10. The method of claim 1, further comprising resetting the corresponding reference counter and enabling the particular block of memory to be reallocated.

11. A non-transitory computer-readable storage medium storing instructions that, when executed by a processor, cause the processor to perform steps comprising:
allocating a first portion of a real storage device (RSD) to store data, wherein the first portion is divided into a plurality of blocks of memory;
allocating a second portion of the RSD to store a plurality of reference counters that correspond to the plurality of blocks of memory; and
disabling access to a particular block of memory in the plurality of blocks of memory based on a value stored in a corresponding reference counter.

12. The computer-readable storage medium of claim 11, wherein access to the particular block of memory is disabled when the value stored in the corresponding reference counter is not equal to a total number of references to the particular block of memory included in a plurality of virtual storage device (VSD) objects.

13. The computer-readable storage medium of claim 12, wherein a reference to the particular block of memory comprises an address that points to the particular block of memory within a mapping table of the VSD object.

14. The computer-readable storage medium of claim 12, wherein a data protection module is configured to determine the total number of references to the particular block of memory by polling each VSD object in a plurality of VSD objects to determine whether each VSD object includes a reference to the particular block of memory in a mapping table of the VSD object.

15. The computer-readable storage medium of claim 11, wherein disabling access to the particular block of memory comprises setting a flag associated with the block of memory, and wherein a block engine daemon is configured to block memory access operations associated with the particular block of memory when the flag is set.

16. The computer-readable storage medium of claim 15, wherein the flag is a most significant bit of the corresponding reference counter

17. A system comprising:
a real storage device (RSD); and
a processor coupled to the RSD and configured to:
allocate a first portion of a real storage device (RSD) to store data, wherein the first portion is divided into a plurality of blocks of memory;
allocate a second portion of the RSD to store a plurality of reference counters that correspond to the plurality of blocks of memory; and
disable access to a particular block of memory in the plurality of blocks of memory based on a value stored in a corresponding reference counter.

18. The system of claim 17, wherein access to the particular block of memory is disabled when the value stored in the corresponding reference counter is not equal to a total number of references to the particular block of memory included in a plurality of virtual storage device (VSD) objects.

19. The system of claim 18, wherein a reference to the particular block of memory comprises an address that points to the particular block of memory within a mapping table of the VSD object.

20. The system of claim 17, wherein disabling access to the particular block of memory comprises setting a flag associated with the block of memory, and wherein a block engine daemon is configured to block memory access operations associated with the particular block of memory when the flag is set.
